(19) United States
(12) Patent Application Publication
(10) Pub. No.: US 2020/0275413 A1
(43) Pub. Date: Aug. 27, 2020

(54) METHOD AND SYSTEM FOR DETERMINING CONFIGURATION PROFILES FOR GRANT FREE COMMUNICATIONS

(71) Applicants: Liqing ZHANG, Ottawa (CA); Jianglei MA, Ottawa (CA); Hua XU, Ottawa (CA); Yongxia LYU, Ottawa (CA)

(72) Inventors: Liqing ZHANG, Ottawa (CA); Jianglei MA, Ottawa (CA); Hua XU, Ottawa (CA); Yongxia LYU, Ottawa (CA)

(73) Assignee: HUAWEI TECHNOLOGIES CO., LTD., SHENZHEN (CN)

(21) Appl. No.: 16/794,331

(22) Filed: Feb. 19, 2020

Related U.S. Application Data
(60) Provisional application No. 62/809,348, filed on Feb. 22, 2019.

(51) Int. Cl. H04W 72/02; H04W 72/04; H04W 72/08; H04W 80/02; H04W 36/06

(52) U.S. Cl. CPC H04W 72/02; H04W 72/048; H04W 72/08; H04W 92/18; H04W 80/02; H04W 36/06; H04W 72/0486

(57) ABSTRACT

An aspect of the disclosure provides a method for grant free communication by an electronic device (ED). Such a method includes receiving a plurality of grant free configuration profiles from a base station; and transmitting to a receiving device, an indication message associated with usage of the plurality of grant free configuration profiles. In some embodiments, the indication message indicates a selected grant free configuration profile. In some embodiments, the indication message indicates at least one of: configuration profile switching; a request for a new configuration profile; transmission parameter changes for a given configuration profile; and a release of a configuration profile. In some embodiments, the selected configuration profile specifies a plurality of data resource blocks, and the indication message indicates which data resource blocks contains data to be decoded by the receiving device. In some embodiments, the indication message is sent via a semi-static control channel.

### CROSS REFERENCE TO RELATED APPLICATIONS

The present application is based on and claims the benefit of U.S. provisional Patent Application No. 62/809,348, titled “METHOD AND SYSTEM FOR DETERMINING CONFIGURATION PROFILES FOR GRANT FREE COMMUNICATIONS”, which was filed on Feb. 22, 2019, the entire content of which is incorporated herein by reference.

### FIELD

The application relates generally to wireless communications, and in particular embodiments, to methods and systems for determining configuration profiles for grant-free transmissions.

### BACKGROUND

In wireless communication systems, an electronic device (ED) wirelessly communicates with a Transmission and Receive Point (TRP), termed “base station”, to send data to the ED and/or receive data from the ED. A wireless communication from an ED to a base station is referred to as an uplink communication. A wireless communication from a base station to an ED is referred to as a downlink communication.

Resources are required to perform uplink and downlink communications. For example, an ED may wirelessly transmit data to a base station in an uplink transmission at a particular frequency and during a particular time slot. The frequency and time slot used is an example of a physical communication resource.

In an LTE grant-based transmission, the required transmission parameters are typically communicated via a Physical Uplink Control Channel (PUCCH) and/or Physical Downlink Control Channel (PDCCH). The base station is aware of the identity of the ED sending the uplink transmission using the granted uplink resources, because the base station specifically granted those uplink resources to that ED. In a grant-free transmission, different EDs may send uplink transmissions using uplink resources initially RRC configured or RRC with DCI configured to each of the EDs. Because the uplink resources have been preconfigured, the ED need not specifically request use of the resources for each data transmission. Further, because the resources are preconfigured the UE need not be granted the resources by the base station for each data transmission. One advantage of grant-free transmission is low latency resulting from not having to request and receive a grant for an allocated time slot from the base station. Furthermore, in a grant-free transmission, the scheduling overhead may be reduced. However, the base station does not have information which ED, if any, is sending a grant-free uplink transmission at a particular moment of time, which may require blind detection of grant-free transmissions received at the base station. In other words, the base station is required to determine which ED is transmitting. Further, because the base station is unaware of whether an ED has transmitted, the base station needs to blindly detect whether a transmission has been received from a given ED.

Further, there can be multiple requirements for different types of data or applications, requiring different grant-free configurations per ED (or UE) to accommodate these different requirements.

Sidelink communication is the transmission and reception between EDs, for example two or more user equipment (UEs), as opposed to Uu-link communication which refers to communication between a UE and a network base station. In other words, an ED can transmit traffic directly to another UE using sidelink communication without requiring the transmission to be sent via a wireless base station. Further, one UE can help one or more other UEs by forwarding their traffic in an SL cooperation group, e.g., by relaying downlink (DL) traffic from a base station (e.g, a gNB) to another UE in the SL cooperation group. The frequency band for transmission between a UE and gNB can be different from the frequency band for SL transmission between UEs, or the frequency band for UL transmission between a UE and gNB can be shared with SL transmission between UEs. SL communications can be useful for vehicle to everything (V2X) communication in which an ED in one vehicle communicates with EDs of other vehicles or roadside EDs. For SL communications for UE cooperation, a co-operating UE (CUE) typically forwards downlink traffic received from a base station to a target UE (TUE). Further, a CUE can forward uplink traffic received via sidelink from a TUE (also referred to as source UE (SUE), in the upward traffic transmission direction) to one or more base stations.

There is a desire in the art for improved methods of selecting resource configurations, and for improved methods of blind detection when multiple resource configurations are available for use.

This background information is provided to reveal information believed by the applicant to be of possible relevance to the present invention. No admission is necessarily intended, nor should be construed, that any of the preceding information constitutes prior art against the present invention.

### SUMMARY

One problem with prior art approaches for grant free communication is that there is a need for multiple types of grant free communication, each with particular requirements. Further, while a base station can allocate different types of grant free configuration profiles to a UE, the base station may not be in the best position to determine the optimal configuration profile to be used by the UE during the transmission procedure. Accordingly an aspect of the disclosure provides solutions in which an electronic device, such as a UE, can select from a plurality of configuration profiles. Such a selection can be based on criteria which a sending electronic device may be in better position to evaluate than a receiving device (such as a base station). These principles can be extended to sidelink communications between electronic devices.

However, as the electronic device is selecting from a plurality of configuration profiles, the receiving device will not necessarily know which profile has been selected. This can lead to a blind detection problem. To reduce the blind detection on multiple resource configurations at the receiver, embodiments utilize control signaling such that the transmitting device sends an indication message associated with usage of the plurality of grant free configuration profiles. Such an indication message informs the receiving device of the configuration profile selected by the transmitting device. Further, in some embodiments the transmitter informs the receiver both as to which configuration profile is selected, and also when to expect data for each configuration profile (e.g., so the receiver need not attempt to detect data in timeslots allocated to the selected configuration profile, but for which no data is transmitted). Such an indication can be sent to the receiving device on a semi-static, dynamic or on-demand basis. For example, such an indication message can be sent using a semi-statically configured control channel, e.g., using uplink control information (UCI) signaling in a physical uplink control channel (PUCCH) for an uplink, or using SCI signaling in a SL control channel). Such an indication message can also inform the receiving device as to changes made (or requested) by the transmitting device to the selected configuration profile(s) or the associated parameters.

An aspect of the disclosure provides a method for grant free communication. Such a method includes receiving, by an electronic device (ED), a plurality of grant free configuration profiles from a base station; and transmitting data, by the ED, to a receiving device using a selected configuration profile from the plurality of configuration profiles. In some embodiments, the method further includes selecting, by the ED, the selected configuration profile from the plurality of configuration profiles (each identified by a configuration index). In some embodiments, selecting, by the ED, the selected configuration profile from the plurality of configuration profiles comprises selecting the profile based on at least one of the following criteria: traffic type, application requirements, packet size, location, mobility, and channel considerations. In some embodiments, the receiving device is the base station. In some embodiments, the receiving device is another ED. In some embodiments, the selected configuration profile is a sidelink configuration profile. In some embodiments, the method further includes informing the receiving device as to the selected configuration profile. In some such embodiments, informing the receiving device as to the selected configuration profile includes semi-statically sending an indication of the selected configuration profile using a control channel. In some embodiments, informing the receiving device as to the selected configuration profile includes multiplexing an indication of the selected configuration profile with the data to be transmitted. In some such embodiments, multiplexing an indication of the selected configuration profile with the data to be transmitted comprises sending the indication via an uplink control information (UCI) header field for packets to be transmitted. In some embodiments, the method further includes receiving a triggering indication that a change should be made to the selected configuration profile; and transmitting an indication of the change to the receiving device. In some embodiments, the indication message can sent via a Media Access Control (MAC) Control Element (CE).

An aspect of the disclosure provides a method for grant free communication. Such a method includes receiving, by an electronic device (ED), a plurality of grant free configuration profiles from a base station; and forwarding the plurality of grant free configuration profiles to another ED using sidelink communication In some embodiments, the ED and the another ED are in a sidelink co-operation group. In some such embodiments, the ED is a co-operating user equipment (CUE) and the another ED is a target user equipment (TUE) for downward traffic from a base station, or a source user equipment (SUE) for upward traffic to one or more base stations.

An aspect of the disclosure provides a method for an enhanced grant free communication. Such a method includes receiving, by an electronic device (ED), a plurality of grant free configuration profiles from a base station; and transmitting, by the ED, to a receiving device, an indication message associated with usage of the plurality of grant free configuration profiles. In some embodiments, the indication message indicates a selected grant free configuration profile or includes a configuration index. In some embodiments, the indication message indicates at least one of: configuration profile switching; a request for a new configuration profile; transmission parameter changes for a given configuration profile; and a release of a configuration profile. In some embodiments, the selected configuration profile specifies a plurality of data resource blocks, and the indication message indicates which data resource blocks contains data to be decoded by the receiving device. In some embodiments, the indication message is sent via a semi-static control channel. In some embodiments, the indication message is multiplexed with the data resource blocks.

An aspect of the disclosure provides for a method. The method includes receiving, by a user equipment (UE), a plurality of configuration profiles for configured grant transmission. The method further includes transmitting, by the UE, an indication of a selected configuration profile selected from the plurality of configuration profiles. The method further includes transmitting data, by the UE, using the selected configuration profile.

Another aspect of the disclosure provides for a UE. The UE includes a processor and a non-transitory machine readable medium including machine executable instructions which when executed by the processor configure the UE to execute the methods described here. For example, UE is configured for receiving a plurality of configuration profiles for configured grant transmission. The UE is further configured for transmitting an indication of a selected configuration profile selected from the plurality of configuration profiles. The UE is further configured for transmitting data using the selected configuration profile.

Another aspect of the disclosure provides for a base station. The base station includes a processor and a non-transitory machine readable medium including machine executable instructions which when executed by the processor configure the base station to execute the methods described here. For example, base station is configured for transmitting, to a user equipment (UE), a plurality of configuration profiles for configured grant transmission. The base station is further configured for receiving, from the UE, an indication of a selected configuration profile selected from the plurality of configuration profiles. The base station is further configured for receiving data, from the UE, using the selected configuration profile.

Other aspects include a base station configured as described, a base station configured as a receiving device as described, and an electronic device for carrying out the methods as described.

### BRIEF DESCRIPTION OF THE DRAWINGS

For a more complete understanding of the present disclosure, and the advantages thereof, reference is now made to the following description taken in conjunction with the accompanying drawings, in which:

FIG. 1 is a schematic diagram of a communication system.

FIGS. 2A and 2B are block diagrams of an example ED and base station, respectively.

FIG. 3A illustrates message flows between an ED and a base station as part of a procedure for configuring, and updating the configuration of the ED, according to an embodiment.

FIG. 3B illustrates message flows between a CUE and a TUE as part of a procedure for configuring, and updating the configuration of the TUE, according to an embodiment.

FIG. 4 schematically illustrates three configuration profiles and a semi-static control channel for informing the receiving device as to which configuration profile is selected, according to an embodiment.

FIG. 5 schematically illustrates three configuration profiles and multiplexed control fields for informing the receiving device as to which configuration profile is selected using uplink control information multiplexed with data transmissions, according to an embodiment.

FIG. 6 is a block diagram of an example ED and base station implemented in modules.

### DETAILED DESCRIPTION

For illustrative purposes, specific example embodiments will be explained in greater detail below in conjunction with the figures. It should be appreciated, however, that the present disclosure provides many applicable concepts that can be embodied in a wide variety of specific contexts. The specific embodiments discussed are merely illustrative and do not limit the scope of the present disclosure.

Aspects of this disclosure provide a grant-free transmission mode for traffic transmissions in a wireless network. In this disclosure, grant-free transmissions (sometimes called “transmissions with configured grant”) refer to data transmissions that are performed without dynamically communicating grant-based signaling by the base station. Grant-free transmissions can include uplink or downlink transmissions, and should be interpreted as such unless otherwise specified. A UE receives multiple configured grant configuration profiles and selects from these profiles a configuration profile to use. These configuration profiles can be received or updated semi-statically or dynamically. For example, GF configuration profiles can be received via RRC only signaling (type 1 GF) or a combination of RRC and DCI signaling (type 2 GF).

### Communication System

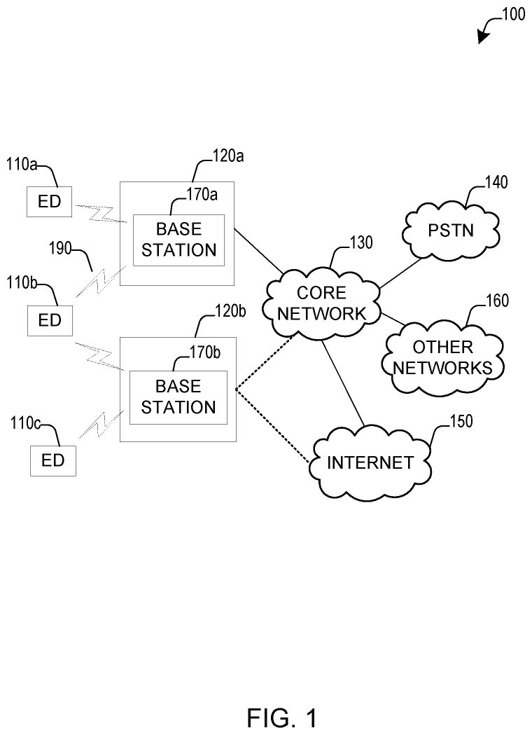

FIG. 1 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, narrowcast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1, any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission point (TP), a site controller, an access point (AP), or a wireless router. The term AP will be used generically to refer to any type of base station. Examples will be discussed in terms of gNB, but other APs can be used. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150, as shown.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

### Hardware Implementation

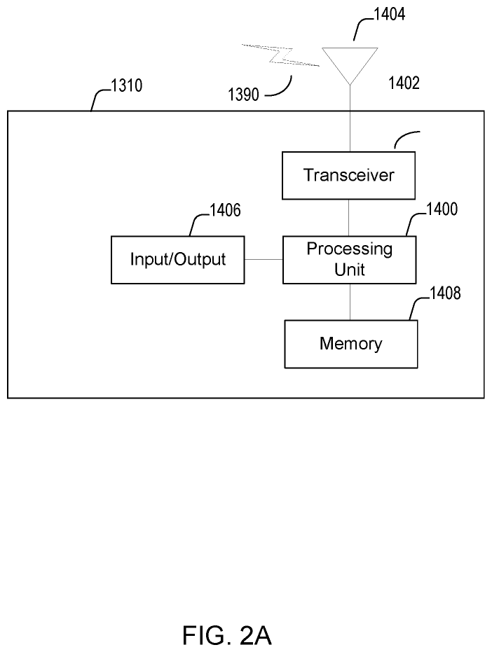

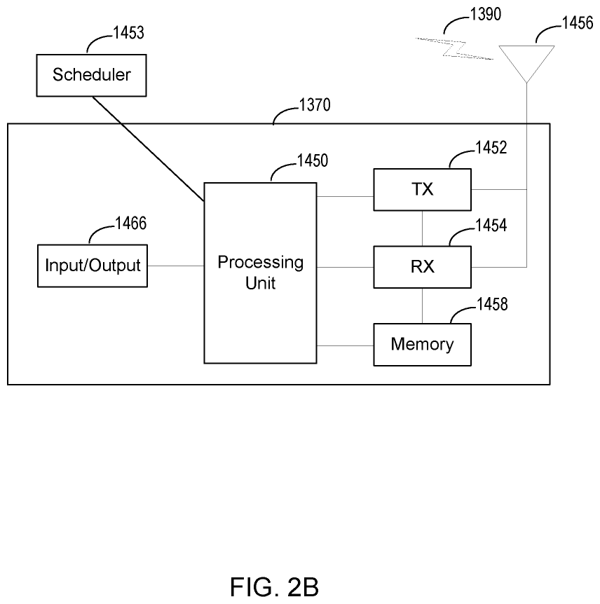

FIGS. 2A and 2B illustrate example devices that may implement the methods and teachings according to this disclosure. In particular, FIG. 2A illustrates an example ED 110, and FIG. 2B illustrates an example base station 170. These components could be used in the communication system 100 or in any other suitable system.

As shown in FIG. 2A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail above. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 2B, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

### Grant-Free Transmissions

The base stations 170 are configured to support wireless communication with EDs 110, which may each send grant-free uplink transmissions. Uplink transmissions from the EDs 110 are performed on a set of time-frequency resources. A grant-free uplink transmission is an uplink transmission that is sent using uplink resources without the base stations 170 dynamically allocating resources to an ED (i.e., without using request/grant mechanisms for each transmission). By performing grant-free transmissions, total network overhead resources may be saved. Furthermore, time savings may be provided by bypassing the request/grant procedure. An ED sending a grant-free uplink transmission, or configured to send a grant-free uplink transmission, may be referred to as operating in grant-free mode. Grant-free uplink transmissions are sometimes called “configured grant”, “grant-less”, “schedule free”, or “schedule-less” transmissions. Grant-free uplink transmissions from different EDs may be transmitted using shared designated resource units, in which case the grant-free uplink transmissions are contention-based transmissions. One or more base stations 170 may perform blind detection of the grant-free uplink transmissions.

In a wireless network according to an embodiment, any ED can be configured for grant-based or grant-free transmissions depending on, e.g., the application and device types and requirements. Usually, a grant-free transmission may require resource (pre-) configuration at the ED connection setup and have resource reconfiguration or an update during operation. In some embodiments, the grant-free resources can be configured for EDs by broadcast or multi-cast signaling in some scenarios. Two or more grant-free transmissions can share the same configured resources. Furthermore, a grant-based transmission can use dedicated resources or can share resources (fully or partially) with grant-free resources in a time interval.

Specific transmission resource areas may be allocated by the base station and signaled (e.g., via RRC signaling) to one or more UEs for such grant-free uplink transmissions. Such an allocation of resources for grant-free transmission is also termed “configured uplink grant” or transmissions with “configured grant (CG)”. The grant-free approach for resource allocation has an advantage of reduced signaling overhead and latency over the scheduling request/uplink scheduling grant approach, but some issues might arise in the grant-free approach. For example, because the same uplink resources can be shared by multiple UEs in a grant-free system, collisions might occur when two or more UEs attempt to use the same resources, Further, another problem is a base station needs to apply blind detection on all configured transmission resources at the receiving end, even if an ED has made no transmissions for a particular transmission resource.

Any of the grant-free and grant-based transmissions can be used for any application traffic or services type, depending on the associated application requirements and quality of service (QoS). By way of a non-limiting example, grant-free transmission can be used for: ultra-reliable low latency communication (URLLC) traffic to satisfy the low latency requirement; enhanced mobile broadband (eMBB) traffic with short packets to save signaling overhead; URLLC traffic having low latency requirements; and eMBB traffic to dynamically take advantage of link adaptation and enhance resource utilization and spectrum efficiency.

One ED or a group of EDs may have a group ID or Radio Network Temporary ID (RNTI; e.g., grant-free (GF)-RNTI or grant-based (GB) RNTI) to share the same parameter or resource configuration. The group ID can be pre-configured, or dynamically configured to each ED. The parameter or resource configuration to the ED(s) with the group ID can be done by semi-static or dynamic signaling. In some embodiments, the group ID can be used for, e.g., resource deactivation or activation for the EDs in the group. In other embodiments, a configuration index with or without the group ID can be used for, e.g., resource deactivation or activation for the EDs in the group. By way of a non-limiting example, the resources being activated or deactivated can include frequency, time, and reference signal (RS) associated with each ED in the group.

### Grant-Free Resource Structure

To support grant-free transmissions, the associated resources configured for an ED or a group of EDs can include any or all of the following:

1) Frequency resources in a transmission time interval (TTI), e.g. a symbol, mini-slot or slot. In one example, a physical resource block (PRB) scheme is provided. The PRB scheme indicates physical starting frequency resource block (RB) and size of the RB.

2) Time resources, including starting/ending position of one data transmission time interval. For example, TTI can be one symbol, mini-slot, or slot.

3) Reference signal (RS) or RS configuration, where each ED can be configured with one or more reference signals (RSs) e.g. demodulation reference signals (DMRSs) depending on scenarios involved. For a group of EDs, each ED may or may not have a different RS or have a different set of RSs (e.g., via configuration of different antenna ports). Note that different RSs can be orthogonal or non-orthogonal to each other depending on an application, e.g., such as URLLC application or massive machine-type communication (mMTC) application.

4) ED/ED group specific hopping parameters, which may include one of the following two parameters. One parameter may include a hopping pattern cycle period. In one embodiment, an absolute reference duration (e.g., 20 TTI before repeating itself) is defined. During the absolute reference duration, the number of hopping steps (e.g., 10 times) to take before repeating the hopping pattern again can be determined based on periodicity of time interval resource accessible for grant-free transmissions (e.g., 2 TTI). In another embodiment, an absolute number of hopping times can be defined, for example hopping 20 times before repeating itself. Other parameter(s) may include a hopping pattern index or indices, where one ED may have one or more hopping pattern indices.

5) One or more hybrid automatic repeat request (HARQ) process IDs per ED.

6) One or more MCSs per ED, where a grant-free ED can indicate explicitly or implicitly which MCS to use for a transmission.

7) Number of grant-free transmission repetitions K. One or more K values can be configured for an ED. Which K value to use depends on certain rules taking into account ED channel conditions, service types, etc. The repetitions allow for duplication of packets for redundancy to ensure delivery of important or time sensitive information (e.g., for URLLC).

8) Power control parameters, including power ramping step size (e.g., for an ED).

9) Other parameters, including information associated with general grant-based data and control transmissions. Note that sometimes, a subset of grant-free resources can be referred to as “fixed” or “reserved” resources; whereas a subset of grant-based resources can be referred to as “flexible” resources, which can be dynamically scheduled by a base station.

### Hybrid Automatic Repeat Requests

As discussed above, the ED 110 may be configured to use a particular set of resources for grant-free transmission. A collision may occur when two or more of the EDs 110 attempt to transmit data on a same set of uplink resources. To mitigate the effect of possible collisions, the EDs 110 may send redundant packets, referred to above as repetitions, in order to ensure at least one repetition is properly received. A retransmission, without grant, of an original grant-free uplink transmission is referred to herein as a “grant-free retransmission”. Any discussion of a grant-free retransmission herein should be understood to refer to either a first or a subsequent retransmission. Herein, the term “retransmission” includes both subsequent transmissions of the originally transmitted packet, as well as retransmissions of different redundancy versions, e.g. using an asynchronous hybrid automatic repeat request (HARQ), that is, a combination of high-rate forward error-correcting coding and physical layer automatic repeat request (ARQ) error control.

In an embodiment, a number of automatic grant-free retransmissions may be pre-configured, to improve reliability and eliminate latency associated with waiting for an acknowledgement (ACK) or a negative acknowledgement (NACK) message. The retransmissions may be performed by the ED 110 until at least one of the following conditions is met:

(1) An ACK message is received from the base station 170 indicating that the base station 170 has successfully received and decoded the TB. The ACK may be sent in a dedicated downlink acknowledgement channel, sent as individual DCI, sent in a data channel, sent as part of a group ACK/NACK, etc.

(2) The number of repetitions reaches K. In other words, if the ED 110 has performed K retransmissions and an ACK is still not received from the base station 170, then the ED 110 gives up trying to send the data to the base station 170. In some embodiments, K is semi-statically configured by the base station 170, such that the base station 170 or the network can adjust K over time.

(3) A grant is received from the base station 170 performing a grant-free to grant-based switch.

The above ACK/NACK and HARQ procedure were described between a UE and a base station. However, it should be appreciated that a similar procedure can be used for SL transmissions, where a transmit UE and a receiving UE can have a similar ACK/NACK and HARQ operation.

In an embodiment, the grant-free retransmission may be triggered by receiving a negative acknowledgment (NACK) message, or failing to receive an acknowledgment (ACK) message. In an alternative embodiment, K grant-free retransmissions are performed irrespective of the response from the base station 170.

The resources over which the one or more grant-free retransmissions are performed may be pre-configured, in which case the base station determines the resources based on a priori information. Alternatively, the resources over which the grant-free initial transmission or one or more retransmissions are performed may be determined e.g. according to an identifier in a pilot signal of the original grant-free uplink transmission. This may allow the base station to predict, or otherwise identify, which uplink resources will carry the one or more retransmissions upon detecting the identifier in the pilot symbol.

Grant-free transmission reduces latency and control overhead associated with grant-based procedures, and can allow for more retransmissions/repetitions to increase reliability. However, due to the lack of uplink scheduling and grant signaling, grant-free EDs may have to be pre-configured to use a fixed modulation and coding scheme (MCS) level at least for initial grant-free transmission. In one embodiment, grant-free EDs are configured to use the most reliable MCS level for a given resource unit for grant-free uplink transmissions.

### Link Adaptation for Grant-Free Transmissions

The use of link adaptation for grant-free transmissions and retransmissions potentially offers several benefits, such as:
Uplink/SL transmissions may occupy fewer resources. For example, EDs with good link quality may be able to use fewer resources by using higher MCS levels.
Spectral efficiency may be increased, and thus the grant-free system capacity may similarly be increased.
Target reliability as characterized e.g. by target residual block error rate (BLER), may be attained more efficiently.

The link adaptation for grant-free communications may be provided by using a semi-static or dynamic signaling. This mechanism may follow an approach similar to that of grant-based uplink dynamic closed loop transmit power control to achieve a target performance metric, such as residual BLER. Other performance metrics that may serve as a target performance metric include, but are not limited to:
The percentage of decoding instances at the base station/a receiving ED resulting in NACKs and/or the percentage of decoding failures, compared to a target threshold.
The percentage of decoding instances at the base station/a receiving ED resulting in ACKs, and/or the percentage of decoding successes, compared to a target threshold.
The SINR gap between the received combined SINR (combined over all HARQ retransmissions of each TB) and the target SINR associated with the current MCS level in use.
Decoding Log Likelihood Ratios (LLRs) calculated by the base station/a receiving ED when attempting to decode a TB after combining all of its retransmissions.

A command for the ED to adjust MCS may be transmitted over a dedicated downlink control channel, e.g. the Physical Downlink Control Channel (PDCCH) or combined with acknowledgement messages over a dedicated downlink acknowledgement channel, e.g. combined with Hybrid Automatic Repeat Request (HARQ) acknowledgements (ACKs/NACKs) transmitted over the Physical HARQ Indicator Channel (PHICH) or other channels.

The grant-free link adaptation may also be initiated at the ED. In one embodiment, an ED can measure downlink channel conditions, and derive uplink channel conditions based on the measured downlink channel conditions. The ED may adapt various parameters of its uplink transmissions based on the assumed uplink channel conditions. The ED may then inform the base station of the adapted transmission parameters. Additionally or alternatively, based on the assumed uplink channel conditions, the ED may send to the base station an indication of a transmission adaptation. This will be discussed in more detail below. In other embodiments, one ED can measure SL channel conditions from another ED, and derive the SL channel conditions of transmissions to the other ED.

Among the uplink transmission parameters that may be adapted are the MCS, packet size, the segmentation of packets, the repetition of packets, and numerology. The numerology may include the spacing of subcarriers in uplink transmissions and the length of the cyclic prefix used in uplink transmissions. Such adaptations may take into account the downlink channel quality measurements, the ED's mobility, pilot signal collisions, the QoS of the ED, including the latency requirement of the ED. In other embodiments, such channel measurement and adaptation mechanisms can directly apply to transmissions in SL, e.g., transmissions between two or more EDs.

The link adaptation for grant-free communications may also be provided by pre-configuring resource groups that with different MCS levels for grant-free transmission with different link conditions. The resource groups can be of different numerologies to enable varying resource configurations. A grant-free ED's long term geometry or path loss and/or transport block packet size may be used to map to a particular one of the pre-configured resource groups.

### Selection of Configuration Profiles

Data for transmission may have different service requirements for an ED, depending on the application sending the data. For example different services or applications can have different Quality of Service (QoS), latency, bandwidth, and/or reliability requirements. For example, as stated above, a URLLC service typically has low latency and high reliability requirements, whereas an eMBB service may have high data rate and high spectral density requirements. However, an MTC service will typically have lower requirements in terms of latency, reliability and data rate. The service requirements can indicate how a grant free communication should be configured in terms of time-frequency resources and other transmission parameters.

As discussed above, an access point (AP) can allocate the grant free (GF) transmission resources based on service requirements in a request, or based on the type of device. For example an ED associated with a utility meter may indicate it will require a configuration for grant free transmission resources for an MTC service. Alternatively, the ED associated with a utility meter will simply be granted a suitable configuration by the AP, based on the AP being able to identify the ED is associated with a utility meter. Note that for Sidelink configuration, it is possible that one ED (e.g., UE) can allocate resources or relay the resource allocations from an AP to one or more EDs, for example, in V2X mode 2 scenarios where the one or more EDs may be out-of-coverage of the AP.

However, an ED, for example a UE, can have multiple types of data to transmit, with each type having different service requirements. Accordingly, for UL transmissions with different user traffic types or different services with different requirements, the UE may be better informed to make decisions on which configuration among different (active) resource configurations to best use for the type of traffic to be transmitted. The AP (or a receiving UE) will not be aware of the best configuration parameters or the best configuration profile to provide to a UE, without signaling overhead (either in an initial request, or in subsequent communication requesting a change to the parameters) or without exchanging information between a transmit UE and a receiving AP or UE.

Aspects of the invention allow for an ED to store a plurality of configuration profiles and select which configuration profile to use for grant free transmission.

In this specification, the term “configuration profile” refers to a set of configuration parameters including time-frequency resource allocations and values for the associated transmission parameters. Accordingly an ED can store a plurality of configuration profiles and select from the stored configuration profiles a configuration profile to use for a grant free transmission. The term “selecting a configuration from multiple resource configurations” is also used for this selection.

A configuration profile may include configuration index, time-frequency resources, repetition, MCS, DMRS, numerology and other transmission parameters as described above with respect to the grant free resource structure. Multiple GF configuration profiles (each with an identification index (also called a configuration index) per UE can be configured to support different services or applications with different QoS or latency/reliability requirements. For example, to support URLLC service with low latency and high reliability requirements, a first configuration profile can be used, whereas an eMBB service with high data rate and high spectral density requirements can use a second configuration profile. For example, the first configuration includes larger subcarrier spacing with larger number of repetitions and the second configuration includes smaller subcarrier spacing with higher spectral density MCS. It should be appreciated that these are just two examples. Thus, multiple resource configurations can be considered to support multiple types of services and applications, each with independent resource and parameter settings.

Each of the multiple configuration profiles can be configured with independent parameter values for time-frequency resources and the associated transmission parameters. An example of 3 different configuration profiles is shown below in table 1, although it should be understood that a different number of configuration profiles could be used. Further, in some embodiments, not all these parameter values will be specified, or additional parameter values can be included.

TABLE 1

| Configuration | |
|---|---|
| Profile | Parameters |
| 1 | configuration index 0, resource periodicity₀, Time- |
| | frequency allocations₀, Repetition₀, MCS₀, DMRS, |
| | NumerologyIndex₀, #ofHARQProcesses₀, etc |
| 2 | configuration index 1, resource periodicity₁, Time- |
| | frequency allocations₁, Repetition₁, MCS₁, DMRS, |
| | NumerologyIndex₁, #ofHARQProcesses₁, etc. |
| 3 | configuration index 2, resource periodicity₂, Time- |
| | frequency allocations₂, Repetition₂, MCS₂, DMRS, |
| | NumerologyIndex₂, #ofHARQProcesses₂, etc. |

Each configuration profile can be pre-configured. In some embodiments, the configuration profiles are configured (or updated) semi-statically or dynamically, for example, by Radio Resource Control (RRC) or L1 (e.g., Downlink Control Information (DCI)) signaling. In some embodiments, all of the parameters are configured using RRC messaging. In some embodiments, some parameters are configured using RRC messaging and other parameters are configures using DCI messaging.

The base station can transmit the multiple configuration profiles on a semi-static or dynamic basis. Semi-static configuration can be achieved via RRC signaling, whereas dynamic configuration can be achieved via a combination of RRC signaling with L1 (e.g., DCI) signaling. Providing the ED with multiple configuration profiles can be done by RRC signaling for each configuration profile, or multiple configuration profiles can be transmitted using a common RRC message. For example, for type 1 GF, a single RRC message is used to configure and activate each resource configuration. In some embodiments, RRC signaling with L1 (e.g., DCI) signaling (e.g., type 2 GF), each downlink control message can activate one configuration. Alternatively, multiple configuration profiles can be transmitted by a single RRC message or a single RRC message with DCI signaling.

The multiple resource configurations can be provided to each ED on an individual ED basis. Alternatively, in some embodiments, a base station can provide a group of EDs the multiple configuration profiles on a per group basis (e.g., using group-cast or multi-cast configuration techniques). It should be appreciated that each configuration profile will have small variations, which can be varied automatically for each subsequent member of the group based on, e.g., the member ID or sub-group number, etc. For type 1 GF, a single RRC signaling can configure and activate a single resource configuration or multiple resource configurations. For Type 2 GF, one DCI can activate one or more configurations.

The ED often has more information regarding the data it is about to send, and its local environment, than the AP (or a receiving ED). Accordingly, the ED is often in a better position to select from among the multiple configuration profiles than the AP (or the receiving ED). The ED can make such a selection based on criteria such as traffic type or based on application requirements. For example, the ED can use criteria, including one or more of the following criteria in selecting a configuration profile from a plurality of configuration profiles:
Traffic type: e.g., URLLC, eMBB and/or mMTC;
Packet size: e.g., short packets or long packets;
Location: e.g., distance to gNB;
Mobility: e.g., channel characteristics changing or mobile device detecting a change in its mobility status; and
Channel: e.g., beaming changing

It is noted that for the traffic type criterion, in some embodiments the ED can use the application type for the application which is providing data to be transmitted in selecting the configuration profile. Further, for the mobility criterion, in some embodiments the ED can detect a change in its mobility status by means of motion/acceleration sensors, or for example, being docked in a cradle of a vehicle, or connecting via bluetooth to a vehicle based application.

It should be appreciated that the GF communication can be used for both UU link (between UEs and the base station) and for Sidelink communication (Tx/Rx between UEs). For SL communication, multiple configuration profiles can be configured by a base station to a UE within the base station signal coverage. If a UE is out-of-coverage of any base station, such a UE can still receive multiple configuration profiles if such a UE is part of a SL co-operation (or co-operative) group using SL communication with at least one UE within range of the base station. Accordingly, after the SL UEs have been synchronized and some of them have been grouped in a SL co-operation (or co-operative) group, a base station can transmit the multiple configuration profiles to a CUE (that is within the base station signal coverage). The CUE will then provide the target UEs (TUEs) with configuration profiles for SL communications. Multiple configuration profiles can be useful for both UU and SL communications. Accordingly, in this specification, a receiving device of a GF transmission will be discussed, which can be a base station (for UU communications) or another ED (for SL communications).

### Adaptation of Configuration Profiles

As discussed above, one issue that might arise using grant-free transmissions involves link adaptation. Link adaptation is how a UE and an access point (or a receiving UE) adapt to changing transmission conditions or how the UE and the access point (or the receiving UE) inform one another of any adaptations either of them has made to the changing conditions. For example, when grant-free resources are allocated to multiple UEs, the same modulation and coding scheme (MCS) can initially be assigned to all of the UEs by the BS. If one of the UEs is in a location with good signal quality, a more aggressive MCS might be more appropriate than the assigned MCS. In a scheduling request/uplink scheduling grant environment, when a change of MCS is appropriate, an access point might assign a different MCS to a UE in an uplink grant. As another example, quadrature phase shift keying (QPSK) can be assigned initially, but some UEs (with Uu link or SL) may indicate or request a change to 16-point quadrature amplitude modulation (16-QAM) if the conditions are beneficial.

As an example, if a UE is in a location with good signal quality and moves to a location with poor signal quality, it can be beneficial for the UE to adapt to the new signal conditions. To do so, the UE might employ a different MCS, transmit with different packet sizes, transmit with repetitions, or make other adaptations.

Accordingly, in addition to the AP initiated link adaptation discussed above, methods will now be discussed for ED initiated link adaptations in such a grant-free environment, as well as how notification of such changes should be communicated between the UE and the access point (or between a CUE and a TUE/SUE for SL communications). Further, in some embodiments, changing parameters other than MCS, including switching entire configuration profiles, can be used. Accordingly, more general transmission adaptation will be used to for changing one or more transmission parameters (including changing configuration profiles.

In an embodiment, techniques are provided for transmission adaptation in wireless networks employing grant-free uplink transmissions. A UE might make measurements of downlink channel conditions and might make assumptions about uplink channel conditions based on the measured downlink channel conditions. The UE might adapt various parameters of its uplink transmissions based on the assumed uplink channel conditions. The UE might then, in one or more manners described in more detail below, inform an access point of the adapted transmission parameters. Alternatively, based on the assumed uplink channel conditions, the UE might send the access point an indication requesting a transmission adaptation. In this case, the initial packet transmission from the UE might still use the previously assigned configuration profile, but the transmission might include the request indication in the data. That is, one portion (e.g., an initial portion, a last portion, etc.) of a data transmission from the UE might include an indicator indicating a request for an assignment of a new configuration profile, or changes to the parameters within a configuration profile, from the access point.

In addition to the UE determining that a configuration change is warranted, a different configuration profile (or changes to a configuration profile) might be assigned to the UE by the access point depending on one or more factors, including the UE configuration profile change request, uplink measurements by the access point, and the traffic situation at the access point. The access point might respond to the UE's transmission adaptation conditions by updating a configuration message for the UE's current configuration profile based on the UE's conditions, the UE's request for a change, system traffic loading, resource availability, or other factors (e.g, uplink measured signal quality from the UE and other UEs at the access point). Alternatively, the access point might reject a configuration message or simply do nothing. If the UE is not able to receive a configuration profile reconfiguration or an update control message from the access point, the UE might continue using the current configuration profile until an update control message for the reconfiguration is received from the access point. The UE can continue using the transmission adaptation indication signals as needed for its transmissions. The access point can reconfigure the UE configuration profile using an update control message, either semi-statically or dynamically, for example, by RRC, broadcast/multicast, or LI (e.g., DCI) signaling, or a combination of the two. Optionally, the configuration profile change might be made for a period of time through the use of a timer or a counter. After the period of time, the UE will revert the UE's configuration profile to the previous configuration profile or to a default configuration profile.

For a transmission adaptation originated from a UE, the configuration profile change might be due to, for example, UE channel condition variations such as downlink pilot measurements, environment changes such as the UE moving to a different network area or changing from a slow moving state to a fast moving state, arrival packet size variations, traffic loading and contention changes, and UE RRC state changes (e.g., from RRC connected state to RRC inactive state or vice versa). A change to configuration profile can also be requested by an ED if the parameters within the configuration profiles are not sufficient, for example to meet the requirements of an application running on the ED.

Among the uplink transmission parameters that might be adapted are the MCS, packet size, and numerology for uplink transmissions; the segmentation of packets; the repetition of packets; and a designation of the resources to be used for data transmission. Further, the ED may also transmit the following types of control information to the AP. An ED can indicate which of several configuration profiles it has selected. This can facilitate detection (e.g., reduce blind detection) by the AP, as will be discussed in more detail below. An ED can also inform the AP of changes the ED has made to a configuration profile, or alternatively, request a new configuration profile (or changes to the parameters within a profile). In some embodiments, the ED can also inform the AP as to the release of one or more configuration profiles, in order to allow the resources to be assigned to other EDs. This can happen, for example, if the ED has no further data to transmit, or the transmitting application has been closed on the ED, or the ED is about to power down, etc.).

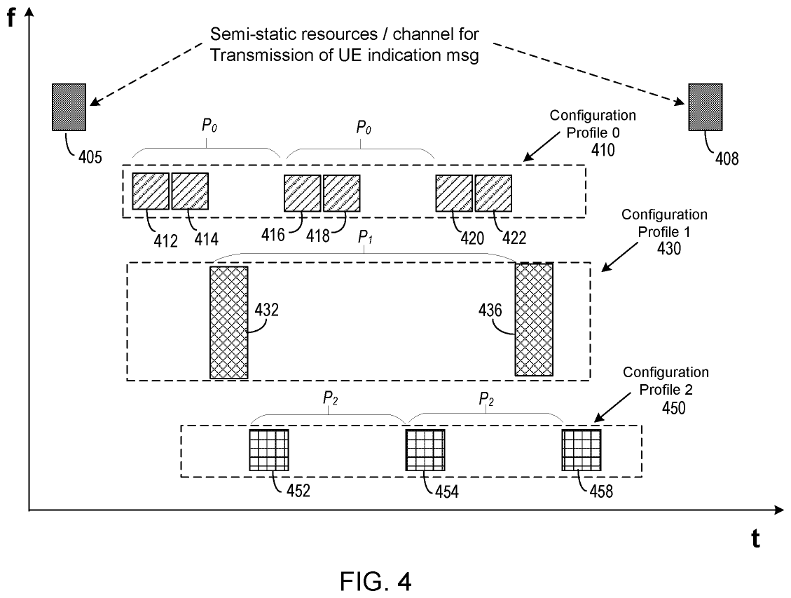

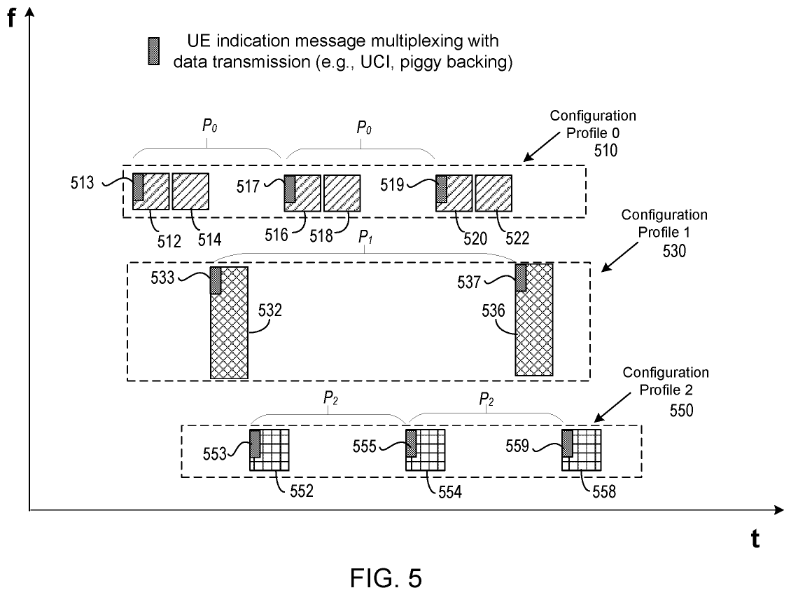

The above described adaptation requests are examples of control messages sent from the UE to the receiving device, which applies to both Uu link and SL, where the receiving device can be either the base station or another ED. For uplink/SL transmissions, a transmit UE can send such control messages to either base station and/or receive UE(s). These control messages can be sent either semi-statically or on demand via a control channel, as will be discussed below with reference to FIG. 4. Alternatively, as will be discussed in more detail below with reference to FIG. 5, such control messages can be sent dynamically, by multiplexing the control messages with the data to be transmitted.

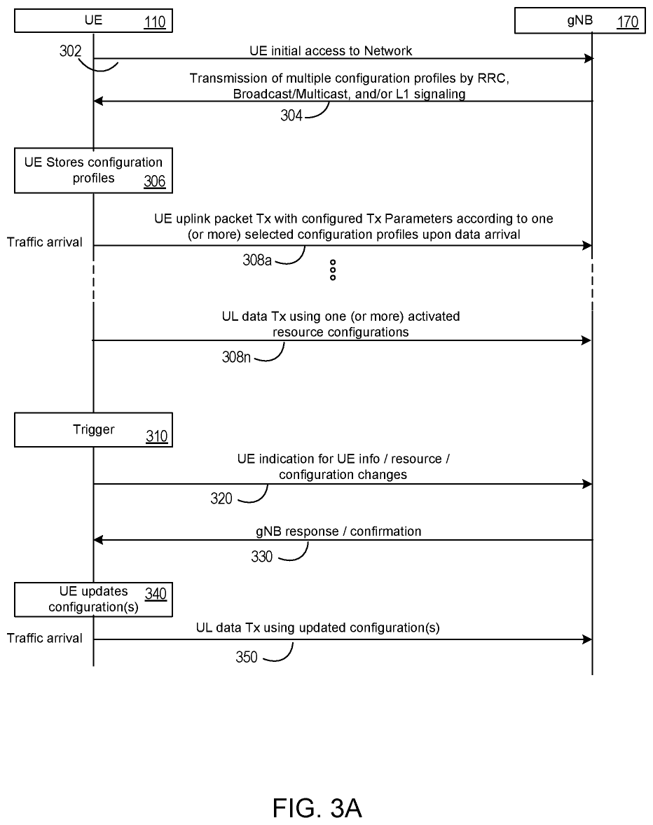

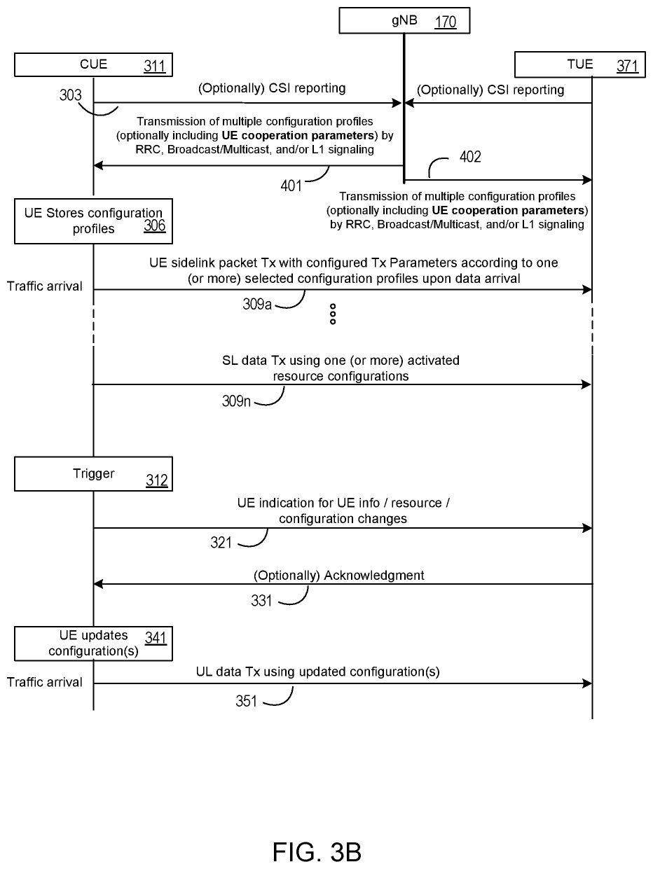

FIG. 3A illustrates message flows between an ED and a base station as part of a procedure for configuring, and updating the configuration of, the ED, according to an embodiment. The UE 110 sends an initial attach request 302 to a base station of the radio access network, for example gNB 170. This request 302 can include a request for GF communication. Alternatively, request 302 can include a request for a UE capability reporting for use with GF. The gNB 170 transmits to the UE 110 multiple configuration profiles using a control message 304, either semi-statically or dynamically, for example, by RRC, broadcast/multicast, and/or LI (e.g., DCI) signaling. As stated, in one embodiment, the gNB 170 sends multiple messages (within one signaling exchange) 304, with each message including a separate configuration profile. In other embodiments, the signaling message 304 can include multiple configuration profiles. The UE 110 stores 306 the multiple configuration profiles in internal memory. As traffic arrives for transmission by the UE 110, for example from an application running on the UE 110, the UE 110 determines whether the traffic should be sent via scheduled or GF communication. For GF transmissions, the UE 110 selects one of the stored configuration profiles for use for the traffic. The UE then transmits the uplink packets 308a . . . 308n using the transmission (Tx) parameters of the selected configuration profile. In some embodiments, the indication signaling or message can be transmitted before or along with data transmission in semi-statically configured resources (e.g., a control channel such as PUCCH or a physical sidelink control channel (PSCCH)) known to the receiving device(s). It is noted that signaling 304, for example UCI signaling, can be carried by the control channel (e.g., PUCCH, PSCCH, etc.). The signaling is used to indicate the selected configuration profile, e.g., by including a configuration index corresponding to the selected configuration profile. In some embodiments, more than one configuration profile can be used for transmitting the packets 308a . . . 308n.

The UE may determine that some configuration parameters should be updated based on a trigger 310, as set out above. Such a trigger 310 can result from a number of adaptation factors such as radio measurements, traffic characteristic changes, by a request from an application running on the UE, or on a demand basis. Accordingly, the UE sends an indication 320 to the gNB 170 for UE information/resource/configuration changes, including active configuration(s) switching, new configuration(s) request, parameter changes within one or more configurations, configuration release, etc. This request/indication can be for parameters within the selected configuration profile, or a request/indication for another profile. In some embodiments, the UE 110 may request/indicate such a change in advance, and await a response/confirmation 330 from the gNB 170. In other embodiments, the indication 320 may inform the gNB 170 of changes the UE 110 has made. In some other embodiments, the indication 320 (UE indication) may inform the gNB 170 of resource release on one or more configurations. In which cases the response/confirmation 330 from the gNB 170 can confirm the changes, reject the changes, or provide other changes for the UE 110 to make. Message 330 can be sent using a DL signaling channel, such as DCI or an RRC reconfiguration message. It is noted that the transmission adaptation message (indication 320) can indicate changes to an entire configuration profile, or parameter updates within one or more active configurations such as MCS update, and other information such as source ID, destination ID, power control instruction, etc. Transmission adaptation message can alternatively indicate activating a smaller set of configurations from all active configuration profiles, or indicate switching from one or more active configurations to a different set of active configurations, or indicate switching from one profile to another profile. The UE then updates the configuration profiles 340 and transmits subsequent packets 350 using the updated profile.

In some embodiments the ED sends a request for a change, which can be accepted or rejected by the receiving device. In such case, the requested change is typically not implemented until a response is received. In other embodiments, an indication is a message notifying the receiving device of a change/switch without waiting for or requiring confirmation from the receiving party (which can be configurable).

FIG. 3B illustrates message flows between a CUE 311 and a TUE 371, according to an embodiment. It is noted that the procedure illustrated in FIG. 3A can be used for UEs using both UU links and SL communications. The procedure illustrated in FIG. 3B can be used for configuration and SL transmissions for UEs within (reliable) coverage from the base station. In the embodiment of FIG. 3B, two (or more) UEs can send their channel measurements and other info (such as UE capability, application QoS) as CSI/capability reporting to the base station 170 as shown in 303. Base station 170 will transmit resource and UE cooperation configuration profiles to the CUE 311 and TUE 371, using UE specific RRC or RRC with DCI signaling as shown by control messages 401, 402 respectively; using group-cast/multi-cast or broadcast signaling for the resource and UE cooperation configurations of the CUE 311 and TUE 371 (thus only one of the messages 401 and 402 is needed for use in this case). In some embodiments, the messages 401, 402 each can include multiple configuration profiles. The CUE 311 stores 306 the multiple configuration profiles in internal memory. Although not shown, TUE 371 will do likewise. As traffic arrives for transmission by the CUE 311, for example from an application running on the CUE 311, the CUE 311 determines whether the traffic should be sent via scheduled or GF communication. For GF transmissions, the CUE 311 selects one of the stored (or alternatively initially pre-configured) configuration profiles for use for the traffic transmission. The CUE 311 then transmits the SL packets 309a . . . 309n using the transmission (Tx) parameters of the selected configuration profile. In some embodiments, the indication signaling or message can be transmitted before or along with data transmission in semi-statically configured resources (i.e., a control channel such as PUCCH or PSCCH) known to the receiving device(s). The signaling is used to indicate the selected configuration profile, e.g., by including a configuration index corresponding to the selected configuration profile. In some embodiments, more than one configuration profile can be used for transmitting the packets 309a . . . 309n and thus the receiving TUE 371 needs to (blind) detect resources configured by each of the active configuration profiles.

Transmission adaptation for more efficient transmission and detection can be made by the CUE 311 that will now be discussed below. CUE 311 can make a determination that a transmission adaptation should occur due to a trigger 312. Such a trigger 312 can result from a number of adaptation factors such as radio measurements, traffic characteristic changes, a request from an application running on the CUE 311, a request from TUE (for which the CUE is forwarding data), or on a demand basis. Accordingly, the CUE 311 sends a UE indication 321 to the TUE 371 for sidelink (SL) information/resource/configuration changes. This UE indication can indicate changes to parameters within the selected configuration profile (such as MCS update, and other information such as source ID, destination ID, power control instruction, etc.), or indicate activating smaller set of configurations from all active configuration profiles or indicate switching from one or more active configurations to a different set of active configurations, or indicate switching from one profile to another profile. In some embodiments, the CUE 311 may indicate such a change in advance, and await a response/confirmation 331 from the CUE 371. In other embodiments, the UE indication message 321 may inform the TUE 371 of releasing one or more active configurations the CUE 311 has made. In the embodiment shown in FIG. 3B, unlike the gNB 170 in FIG. 3A, the TUE 371 may not be able to reject or change the parameters. In some embodiments, the TUE 371 acknowledges the change CUE 331 via a sidelink feedback channel such as a physical SL feedback channel (PSFCH). In one embodiment, the CUE 311 will update the configuration profiles 341 upon receiving an acknowledgement from the TUE 371. In embodiments in which no acknowledgement is required, the CUE 311 will update the configuration profiles 341 regardless of receiving an acknowledgement or not from the TUE 371. The CUE 311 then transmits subsequent packets 351 using the updated profile(s). Note that this procedure can be extended for SL communications even if no co-operative group has been established. In which case the transmission and information exchanging procedure can apply also to general SL communications, where CUE is a transmit UE and TUE is a receiving UE.

For UEs out of coverage from the base station, one or more in-coverage UEs (CUE) can assist other out-of-coverage UEs (e.g., TUE) to obtain system synchronization and assist their resource configurations (each UE with one or multiple configuration profiles). For example, if TUE 371 is out of range of gNB 170, and gNB is informed that CUE 311 and TUE 371 are in a SL co-operative group, or CUE 311 plays a role of master UE, then gNB 170 can send the configuration profile message 402 to CUE 311 to forward to TUE 371. In other words, if TUE 371 is out of coverage range from the base station 170, the configuration control message 402 from the base station 170 to TUE 371 can be transmitted to CUE 311. The in-coverage CUE 311 then retransmits the configuration profiles intended for TUE 371 using a sidelink control channel such as a physical SL control channel (PSCCH)

### Facilitating Detection

As multiple configuration profiles per UE can be configured and set to active for uplink/SL transmissions, this means that a UE can transmit a data packet using any one of these multiple resource configurations, because the UE selects the configuration profile to use. However, the receiver has no knowledge of which configuration profile the UE has selected for transmission. This means the receiving device (SL UE or gNB) will need to implement blind detection on each of the (active) configurations for each transmitting device, leading to a high reception complexity. In other words, the gNB/TUE has to blind detect all the configured resources from the multiple (active or activated) configuration profiles for each UE.

To reduce the blind detection on multiple resource configurations at the receiver, embodiments utilize control signaling such that the transmitting device informs the receiving device of the configuration profile selected by the transmitting device. Further, in some embodiments the transmitter informs the receiver both as to which configuration profile is selected, and also when to expect data for each configuration profile (e.g., so the receiver need not attempt to detect data in timeslots allocated to the selected configuration profile, but for which no data is transmitted). Such an indication, which may or may not include a configuration index (or configuration indices), can be sent to the receiving device on a semi-static, dynamic or on-demand basis. In other embodiments, the indication can be sent to the receiving device in a control channel. Such a control channel can be semi-statically or dynamically configured.

FIG. 4 schematically illustrates three configuration profiles and semi-statically configured control channel (or pre-configured control channel by RRC) for transmission of UE indication message that informs the receiving device as to which configuration profile is selected for data transmission, according to an embodiment. In other embodiments, the control channel for transmission of UE indication message can be configured in a semi-static way. Thus a transmit device may periodically indicates (or requests) to a receiving device as to which configuration profile to be selected, or which configuration profile to switch to or be activated, among multiple configuration profiles for data transmissions; the receiving device may or may not need to confirm or acknowledge the indication or the request from the transmit device. FIG. 4 illustrates three configuration profiles in terms of frequency (f) and time (t) allocations, namely configuration profile 0 410, configuration profile 1 430 and configuration profile 2 450, each configuration is made in a way of defining one data resource block(s) or resource occasion(s) in one period, and repeating the resources periodically in each period P Configuration profile 0 410 includes successive data resource block allocations (in time and frequency) 412, 414 for transmission of one packet with one redundant transmission (i.e., repetitions of K=2: an initial plus one redundant transmission) in a period P₀, and the resource block allocations will be extended periodically such as, the blocks 416, 418 in another period P₀, and the blocks 420, 422 in the following period, etc. Configuration profile 1 430 includes data resource block 432 in a period, and repeats this resource blocks periodically with periodicity P₁, for example, the next data resource block allocation is 436 whose time distance from 432 is the period P₁. Configuration profile 2 450 includes data resource blocks 452, 454, and 456 within three periods, each period duration P₂ has one resource block configured. It is noted that P₀, P₁, P₂ are resource configuration periodicity parameters, respectively, for each configuration profile. Once these multiple configuration profiles already configured, the transmitting device informs the receiving device as to the selected configuration profile by including the corresponding configuration index in an UE indication message. In some embodiments, ongoing indication messages also specify which channel to transmit that required configuration. For example, FIG. 4 illustrates semi-statically configured a series of channels for transmission of UE indication messages, where the two channels 405 and 408 are part of a series channels. For a UU link, a PUCCH is an example of such a semi-statically configured control channel. For SL, a semi-statically configured control channel can be used for transmission of an indication message. In some embodiments, on demand control information is used. For example, the channel 405 or channel 408 will be used to transmit the UE indication or control information immediately before the first data packet is transmitted for a burst of data packets, or when there is data being transmitted. For example, the UE indication message transmitted (if existing) in channel 405 or 408 will tell/request (by configuration index or indices) the receiver which one or more of the configured profiles (e.g., 1, 2, 3) to be applied for (current or next) data transmissions.

FIG. 5 schematically illustrates three configuration profiles and multiplexed control fields for informing the receiving device as to which configuration profile is selected using uplink control information multiplexed with data transmissions, according to an embodiment. FIG. 5 illustrates three configuration profiles in terms of frequency (f) and time (t) allocations, namely configuration profile 0 510, configuration profile 1 530 and configuration profile 2 550, each configuration is made in a way of defining one data resource block(s) or resource occasion(s) in one period, and repeating the resources periodically in each period P. Configuration profile 0 510 includes successive data resource block allocations (in time and frequency) 512, 514 in one period P₀, and repeats periodically the time allocations in each following period, e.g., the resource blocks 516, 518 in the next period P₀, and resource blocks 520, 522 in the following period P₀. Configuration profile 1 530 includes data resource block 532 in one period, and 536 in the following period P₁, and so on Configuration profile 2 550 includes data resource blocks 552 in one period, and one resource block 554 in the next period, and the resource block 556 in the following period P₂, and so on. The transmitting device sends control information/UE indication message which informs the receiving device as to the selected configuration profile, as well as which part of data resource blocks will include data. For example, FIG. 5 illustrates a multiplexed control channel, with the control channel information/UE indication message multiplexed with the data to be transmitted. Accordingly, the multiplexed control channel is illustrated as control block 513 location within data resource blocks 512, control block 517 location within data resource blocks 516 and control block 519 location within data resource blocks 520 for configuration profile 0 510. For configuration profile 1 530 the multiplexed control channel is illustrated as control block 533 location within data resource block 532 and control block 537 location within data resource block 536. For configuration profile 2 550 the multiplexed control channel is illustrated as control blocks 553, 555 and 559 locations within data resource blocks 552, 554 and 558, respectively. In another embodiment, the multiplexed control information can be done using data resource by punctuation of the data channel such as for 512. In some embodiments, the control blocks always include control information. In other embodiments, the control blocks only include control information for data resource blocks which include data (as opposed to empty data blocks. In some embodiments, the UE can transmit control information (e.g., control blocks) even when there is no data to be transmitted . . . In some embodiments, the control blocks use an uplink control information (UCI) format. Accordingly, blind detection is reduced because the receiving device can detect the UCI blocks to get specific parameters such as MCS used in the data transmission or possible configuration switching. If a UCI block is detected, the receiving device decodes the data in the associated data resource block based on the UCI information. If no UCI is detected for a given data resource block, then the receiving device does not need to attempt to decode data for the associated data resource block because there is no data being transmitted.

As discussed, the UE can send a UE indication message informing the receiving device as to the selected CG configuration profile. While examples are discussed herein for a UE indication message, the UE is an example of an ED, such that the examples extend generally to an ED indication message. In some embodiments the UE indication message also advise the receiving device which data resource blocks include data to be decoded or any update on the associated transmission parameter(s). Such a UE indication message(s) can be sent using PUCCH for UU communications. For SL, such a UE indication message(s) can be sent using SL feedback channel or PSCCH. Such a UE indication message can be sent on demand. In some embodiments such a UE indication message can be multiplexed with data, or use a dynamic indication such as using UCI. In some embodiments the UE indication message may or may not include an HARQ ID to the base station or a receiving UE. Other UE indication messages can include the following: one, more, or a combination of
Msg type A: UE indication/request for activation using a configuration index or configuration indices, or for switching to one or more configurations;
Msg type B: UE indication/request for release one or more configurations (with index or indices);
Msg type C: UE indication/request for adding new resource configuration(s) (with index or indices, optionally with traffic and/or CSI reporting);
Msg type D: UE indication/request for updating parameters for current active configuration(s) (with index or indices, optionally with traffic and/or CSI reporting).
UE side information such as traffic type, application QoS, channel condition, interference, mobility, or/and other measurements.

The receiving device can respond to such a UE indication message. In UU, gNB will either confirm or provide a re-configuration. Such a response can be via RRC, DCI or a combination of the two. For example, in some embodiments, gNB may confirm UE request by DCI, and/or gNB may re-configure based on UE info by DCI or RRC. In some embodiments, such a response can include possible configuration switching, parameter update, add new configurations or release any resource configuration(s). In some embodiments, such a response can include include HARQ ID (for signal HARQ combination and feedback) based on current active resource configurations. For SL and UE cooperation, in some embodiments, TUE(s) will follow the indication from a CUE under one or multiple configuration scenarios. In some embodiments, SL receiving UE can follow the indication from the transmit UE with or without direct acknowledgement. For example, the TUE will apply a configuration profile sent by the CUE in the UE indication message. In other embodiments, SL receiving UE can follow the indication from the transmit UE with indirect or implicit acknowledgement.

In some embodiments, such a UE indication message can be sent using one or more of the following formats:
Enhanced UCI/CSI-report channel to include these UE indication
   Dedicated UL control channel, e.g., PUCCH
   Can be transmitted in same or different time slots with PUSCH
   gNB can detect this control information before data decoding to reduce blind detection
   Multiplexing with PUSCH or SL data channel, e.g., separately encoded like one CB, that is, multiplexing UE indication message with PUSCH/SL data channel using rate matching, punctuation, etc.
A SL control channel for the indication message
   A new SCI format different from the current one that used for resource configuration and transmission scheduling
   A simplified version of SCI from the current one that used for resource configuration and transmission scheduling
   Transmitting an indication message before or same time along with a data transmission
Piggyback with the PUSCH or SL data channel.
   Using MAC CE
Depend on the info to carry, different formats are possible for UE indication message
   Bitmap for different resource usage request
   Indication bits to indicate intended configuration index for its activation, release, or switch from
   Only UE associated info or DL/SL measurement reporting

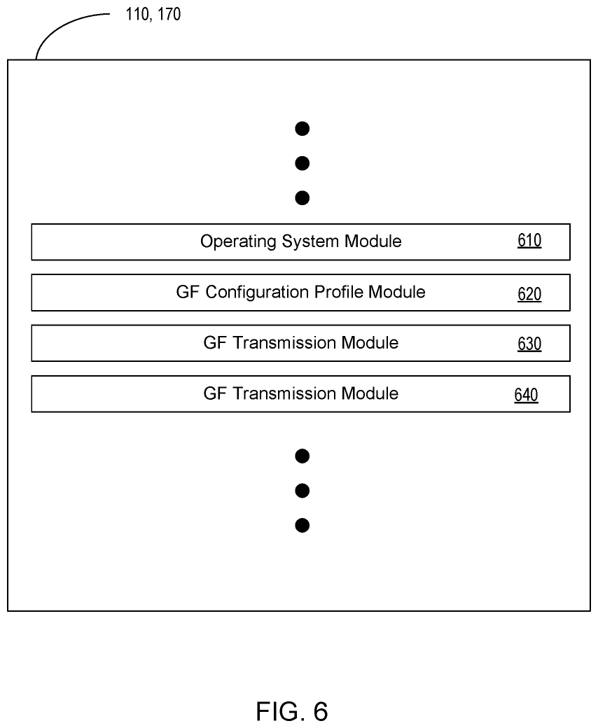

It should be appreciated that one or more steps of the embodiment methods provided herein may be performed by corresponding units or modules, according to FIG. 6. For example, a signal may be transmitted by a transmitting unit or a transmitting module, such as GF transmission module 630. A signal may be received by a receiving unit or a receiving module (not shown). A signal may be processed by a processing unit or a processing module, such as operating system module 610. GF configuration profile module 620 receives and stores configuration profiles, and selects a configuration profile to be used for particular traffic, for transmission by the GF transmission module. FIG. 6 also includes a GF adaptation module 640, which determines whether a transmission adaption should be made, and sends the appropriate request/inform messages for transmission adaption. It should be appreciated that an ED will have other units or modules not germane for this discussion. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Additional details regarding the EDs 110 and the base stations 170 are known to those of skill in the art. As such, these details are omitted here for clarity.

An aspect of the disclosure provides for a method. The method includes receiving, by a user equipment (UE), a plurality of configuration profiles for configured grant transmission. The method further includes transmitting, by the UE, an indication of a selected configuration profile selected from the plurality of configuration profiles. The method further includes transmitting data, by the UE, using the selected configuration profile. In some embodiments, the method further includes selecting, by the UE, the selected configuration profile based on at least one of the following criteria: traffic type, application requirements, packet size, device location, mobility, and channel condition. In some embodiments, the step of receiving includes receiving the plurality of configuration profiles from a base station. In some embodiments, the step of transmitting includes transmitting to the base station. In some embodiments, the selected configuration profile is a sidelink configuration profile. In some embodiments, the step of transmitting data includes transmitting to another UE using the sidelink configuration profile. In some embodiments, the UE operates as a cooperating user equipment (CUE). In some embodiments, the another UE operates as a target user equipment (TUE). In some embodiments, the CUE and the TUE are in a UE co-operation group. In some embodiments, the step of transmitting, by the UE, an indication of a selected configuration profile includes transmitting the indication separately from the data. In some embodiments, the selected configuration profile specifies a plurality of data resource blocks, and the indication indicates which data resource blocks contains data to be decoded by a receiving device. In some embodiments, the step of transmitting, by the UE, an indication of a selected configuration profile includes transmitting the indication multiplexed with the data. In some embodiments, the indication is sent using a Media Access Control (MAC) Control Element (CE). In some embodiments, the indication includes at least one of a configuration index and a configuration profile switching message. In some embodiments, the method further includes transmitting, by the UE, a control message. In some embodiments, the control message includes a request for a new configuration profile. In some embodiments, the control message further includes a release of a configuration profile. In some embodiments, the control message further includes a message indicating a transmission parameter change for a given configuration profile. In some embodiments, the method further includes receiving, by the UE, a triggering indication prompting a reselection from the plurality of configuration profiles. In some embodiments, the method further includes transmitting, by the UE, an indication of the reselection.

Another aspect of the disclosure provides for a UE. The UE includes a processor and a non-transitory machine readable medium including machine executable instructions which when executed by the processor configure the UE to execute the methods described here. For example, UE is configured for receiving a plurality of configuration profiles for configured grant transmission. The UE is further configured for transmitting an indication of a selected configuration profile selected from the plurality of configuration profiles. The UE is further configured for transmitting data using the selected configuration profile. In some embodiments, UE is further configured for selecting the selected configuration profile based on at least one of the following criteria: traffic type, application requirements, packet size, device location, mobility, and channel condition. In some embodiments, the configuration of UE for receiving includes receiving the plurality of configuration profiles from a base station. In some embodiments, the configuration of UE for transmitting includes transmitting to the base station. In some embodiments the selected configuration profile is a sidelink configuration profile. In some embodiments the configuration of UE for transmitting data includes transmitting to another UE using the sidelink configuration profile. In some embodiments the UE is further configured to operates as a cooperating user equipment (CUE). In some embodiments, the another UE operates as a target user equipment (TUE). In some embodiments, the CUE and the TUE are in a UE co-operation group. In some embodiments, the configuration of UE for transmitting an indication of a selected configuration profile includes transmitting the indication separately from the data. In some embodiments, the selected configuration profile specifies a plurality of data resource blocks, and the indication indicates which data resource blocks contains data to be decoded by a receiving device. In some embodiments, the configuration of UE for transmitting an indication of a selected configuration profile includes transmitting the indication multiplexed with the data. In some embodiments the indication is sent using a Media Access Control (MAC) Control Element (CE). In some embodiments, the indication includes at least one of a configuration index and a configuration profile switching message. In some embodiments, the UE is further configured for transmitting a control message including. In some embodiments, the control message includes a request for a new configuration profile. In some embodiments, the control message further includes a release of a configuration profile. In some embodiments, the control message further includes a message indicating a transmission parameter change for a given configuration profile. In some embodiments, the UE is further configured for receiving a triggering indication prompting a reselection from the plurality of configuration profiles. In some embodiments, the UE is further configured for transmitting an indication of the reselection.

Another aspect of the disclosure provides for a base station. The base station includes a processor and a non-transitory machine readable medium including machine executable instructions which when executed by the processor configure the base station to execute the methods described here. For example, base station is configured for transmitting, to a user equipment (UE), a plurality of configuration profiles for configured grant transmission. The base station is further configured for receiving, from the UE, an indication of a selected configuration profile selected from the plurality of configuration profiles. The base station is further configured for receiving data, from the UE, using the selected configuration profile. In some embodiment, the base station is further configured for sending instructions to the UE to select a configuration profile based on at least one of the following criteria: traffic type, application requirements, packet size, device location, mobility, and channel condition. In some embodiments the plurality of configuration profiles is a plurality of sidelink configuration profiles. In some embodiments, the configuration of the base station for receiving, from the UE, an indication of a selected configuration profile includes receiving the indication separately from the data. In some embodiments, the selected configuration profile specifies a plurality of data resource blocks, and the indication indicates which data resource blocks contains data to be decoded by the base station. In some embodiments, the configuration of base station for receiving, from the UE, an indication of a selected configuration profile includes receiving the indication multiplexed with the data. In some embodiments, the indication is received using a Media Access Control (MAC) Control Element (CE). In some embodiments, the indication includes at least one of a configuration index and a configuration profile switching message. In some embodiments, the base station is further configured for receiving a control message. In some embodiments the control message includes a request for a new configuration profile. In some embodiments the control message further includes a release of a configuration profile. In some embodiments the control message further includes a message indicating a transmission parameter change for a given configuration profile. In some embodiments the base station is further configured for transmitting, to the UE, a triggering indication prompting a reselection from the plurality of configuration profiles. In some embodiments the base station is further configured for receiving, from the UE, an indication of the reselection.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by a user equipment (UE), a plurality of configuration profiles for configured grant transmission;
transmitting, by the UE, an indication of a selected configuration profile selected from the plurality of configuration profiles; and
transmitting data, by the UE, using the selected configuration profile.

2. The method of claim 1 further comprising selecting, by the UE, the selected configuration profile based on at least one of the following criteria: traffic type, application requirements, packet size, device location, mobility, and channel condition.

3. The method of claim 1 wherein receiving comprises receiving the plurality of configuration profiles from a base station.

4. The method of claim 3 wherein transmitting comprises transmitting to the base station.

5. The method of claim 3 wherein:
the selected configuration profile is a sidelink configuration profile;
transmitting data comprises transmitting to another UE using the sidelink configuration profile.

6. The method of claim 5 wherein:
the UE operates as a cooperating user equipment (CUE);
the another UE operates as a target user equipment (TUE); and
the CUE and the TUE are in a UE co-operation group.

7. The method of claim 1 wherein transmitting, by the UE, an indication of a selected configuration profile comprises transmitting the indication separately from the data.

8. The method of claim 7 wherein the selected configuration profile specifies a plurality of data resource blocks, and the indication indicates which data resource blocks contains data to be decoded by a receiving device.

9. The method of claim 1 wherein transmitting, by the UE, an indication of a selected configuration profile comprises transmitting the indication multiplexed with the data.

10. The method of claim 9 wherein the indication is sent using a Media Access Control (MAC) Control Element (CE).

11. The method of claim 10 wherein the indication comprises at least one of:
a configuration index; and
a configuration profile switching message.

12. The method of claim 1 further comprising transmitting, by the UE, a control message comprising:
a request for a new configuration profile;
a release of a configuration profile; and
a message indicating a transmission parameter change for a given configuration profile.

13. The method of claim 1 further comprising:
receiving, by the UE, a triggering indication prompting a reselection from the plurality of configuration profiles; and
transmitting, by the UE, an indication of the reselection.

14. A user equipment (UE) comprising:
a processor; and
non-transitory machine readable medium comprising machine executable instructions which when executed by the processor, configure the UE for:
receiving a plurality of configuration profiles for configured grant transmission;
transmitting an indication of a selected configuration profile selected from the plurality of configuration profiles; and
transmitting data using the selected configuration profile.

15. The UE of claim 14 further comprising instructions for configuring the UE for selecting the selected configuration profile based on at least one of the following criteria: traffic type, application requirements, packet size, device location, mobility, and channel condition.

16. The UE of claim 14 wherein receiving comprises receiving the plurality of configuration profiles from a base station.

17. The UE of claim 16 wherein transmitting comprises transmitting to the base station.

18. The UE of claim 16 wherein:
the selected configuration profile is a sidelink configuration profile;
transmitting data comprises transmitting to another UE using the sidelink configuration profile.

19. The UE of claim 18 wherein:
the UE operates as a cooperating user equipment (CUE);
the another UE operates as a target user equipment (TUE); and
the CUE and the TUE are in a UE co-operation group.

20. The UE of claim 14 wherein transmitting an indication of a selected configuration profile comprises transmitting the indication separately from the data.

21. The UE of claim 20 wherein the selected configuration profile specifies a plurality of data resource blocks, and the indication indicates which data resource blocks contains data to be decoded by a receiving device.

22. The UE of claim 14 wherein transmitting an indication of a selected configuration profile comprises transmitting the indication multiplexed with the data.

23. The UE of claim 22 wherein the indication is sent using a Media Access Control (MAC) Control Element (CE).

24. The UE of claim 23 wherein the indication comprises at least one of:
a configuration index; and
a configuration profile switching message.

25. The UE of claim 14 wherein the instructions further configure the UE for transmitting a control message comprising:
a request for a new configuration profile;
a release of a configuration profile; and
a message indicating a transmission parameter change for a given configuration profile.

26. The UE of claim 14 wherein the instructions further configure the UE for:
receiving a triggering indication prompting a reselection from the plurality of configuration profiles; and
transmitting an indication of the reselection.
